(19) United States
(12) Patent Application Publication
(10) Pub. No.: US 2010/0325444 A1
(43) Pub. Date: Dec. 23, 2010

(54) DOCUMENT ENCRYPTING SYSTEM AND METHOD THEREOF

(75) Inventor: KUI-JUN WANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY(ShenZhen) CO., LTD., Shenzhen City (KR); HON HAI PRECISION INDUSTRY CO., LTD., Tu-Cheng (TW)

(21) Appl. No.: 12/690,932

(22) Filed: Jan. 21, 2010

(30) Foreign Application Priority Data
Jun. 19, 2009 (CN) 200910303460.0

(51) Int. Cl. G06F 21/00

(52) U.S. Cl. 713/189

(57) ABSTRACT

A document encrypting system encrypts data by comparing an ongoing operation with a number of predetermined restricted operations and generating a protection password according to a predetermined operation number and a predetermined computing rule.

### BACKGROUND

1. Technical Field

The present disclosure relates to document processing technology and, particularly, to a document encrypting system and an encrypting method.

2. Description of Related Art

Generally, a document processing application/system protects a document by presetting a password for the document. The document password is inputted before accessing the document. However, if certain privileges, such as copy and paste, are restricted to protect the integrity of the document, this may be difficult to implement.

Therefore, it is desirable to provide a document encrypting system and method for using the document encrypting system which can overcome the above-mentioned problems.

### BRIEF DESCRIPTION OF THE FIGURE

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a functional block diagram of a document encrypting system, according to an exemplary embodiment.

FIG. 2 is a flowchart of a document encrypting method, according to another exemplary embodiment.

### DETAILED DESCRIPTION

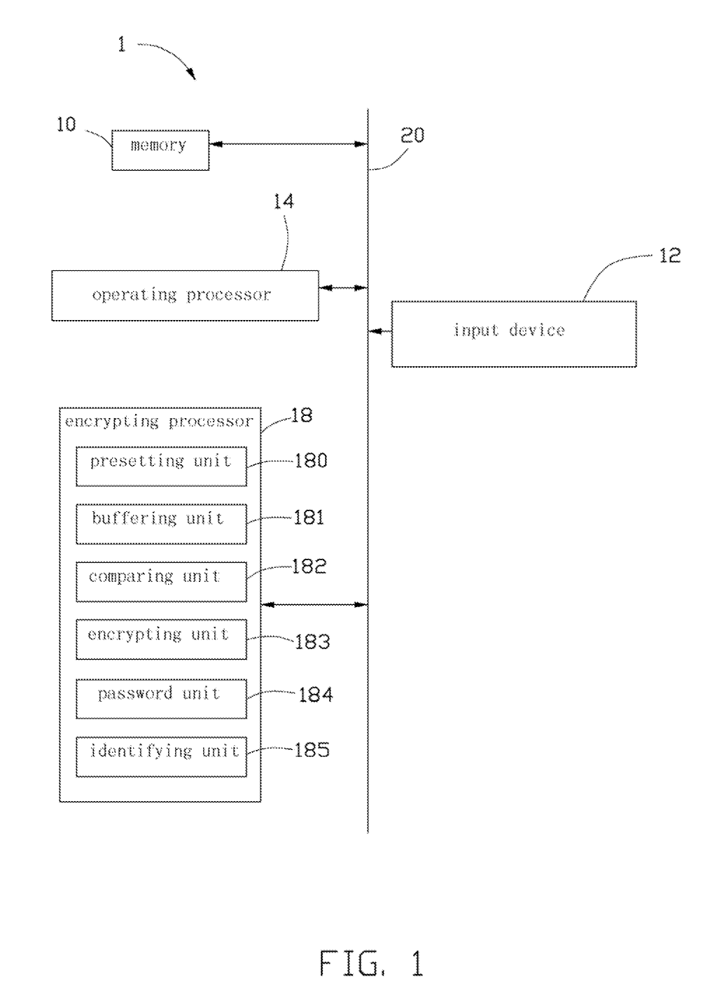

Referring to FIG. 1, a document encrypting system 1, according to an exemplary embodiment, includes a memory 10, an input device 12, an operating processor 14, an encrypting processor 18, and an input/output (I/O) bus 20.

The memory 10 is typically a non-volatile storage, and is for storing a document that can be accessed by the operating processor 14. The memory 10 is connected to the operating processor 14 and the encrypting processor 18.

The input device 12 can be a keyboard, a touch screen, or a mouse. The users can perform an action through the input device 12.

The operating processor 14 is configured for detecting an illegal action (rescinded privilege) performed on the document by the input device. For example, an illegal action can be pressing the Ctrl+c (which is the copy shortcut) or pressing the delete or backspace keys for deleting texts.

The encrypting processor 18 is configured for generating a protection password when the document is illegally operated. The encrypting processor 18 includes a presetting unit 180, a buffering unit 181, an identifying unit 185, a comparing unit 182, an encrypting unit 183, and a password unit 184.

The presetting unit 180 is configured for presetting a primary password, an operation number, and a number of restricted actions. The restricted actions may lead to an alteration or a divulgence of the document, for example: a copy action, a cut action, a delete action, and a paste action.

The operation number is a signed number, such as a signed decimal number. The sign of the operation number is plus or minus. The plus operation number corresponding to add the magnitude of the operation number to a base number. The minus operation number corresponding to subtract the magnitude of the operation number from the base number in an encrypting operation operated by the encrypting unit 183.

The buffering unit 181 is configured for buffering the primary password, the operation number, and the restricted actions.

The identifying unit 185 is configured for identifying if the document is operated by an author who creates the document via inputting the primary password. The identifying unit 185 generates and transmits a terminate instruction to the comparing unit 182 if the document is operated by the author.

The comparing unit 182 is configured for comparing the actions detected by the operating processor with the restricted actions and transmitting a warning instruction to the encrypting unit 183 if the action performed on the document is the restricted actions.

The comparing unit 182 terminates the comparison when it receives the terminate instruction from the identifying unit 185. That is, if the document is operated by the author, any action can be directly executed without further identification whether the action is restricted or not.

The encrypting unit 183 is configured for terminating the ongoing restricted actions and breaking off access to the document upon receipt of the warning instruction and generating the protection password.

The encrypting unit 183 random generates at least one character ASCII code as the base number and computes the base number and the operation number following a predetermined computing rule to get the protection password. For example: if the predetermined computing rule is the hexadecimal addition, the ASCII codes generated by the input device 12 are 1E, 30, 2E, 02, 03, 04, and the operation number is 2, then, the protection password is a number string: 20, 32, 30, 04, 05, 06. The encrypting unit 183 encrypts the document using the protection password.

The password unit 184 is configured for generating a password document to store the protection password and encrypting the password document using the primary password. Therefore, if the document is encrypted, only the author can open the password document to get the protection password.

The components mentioned above are interconnected to each other through the I/O bus 20.

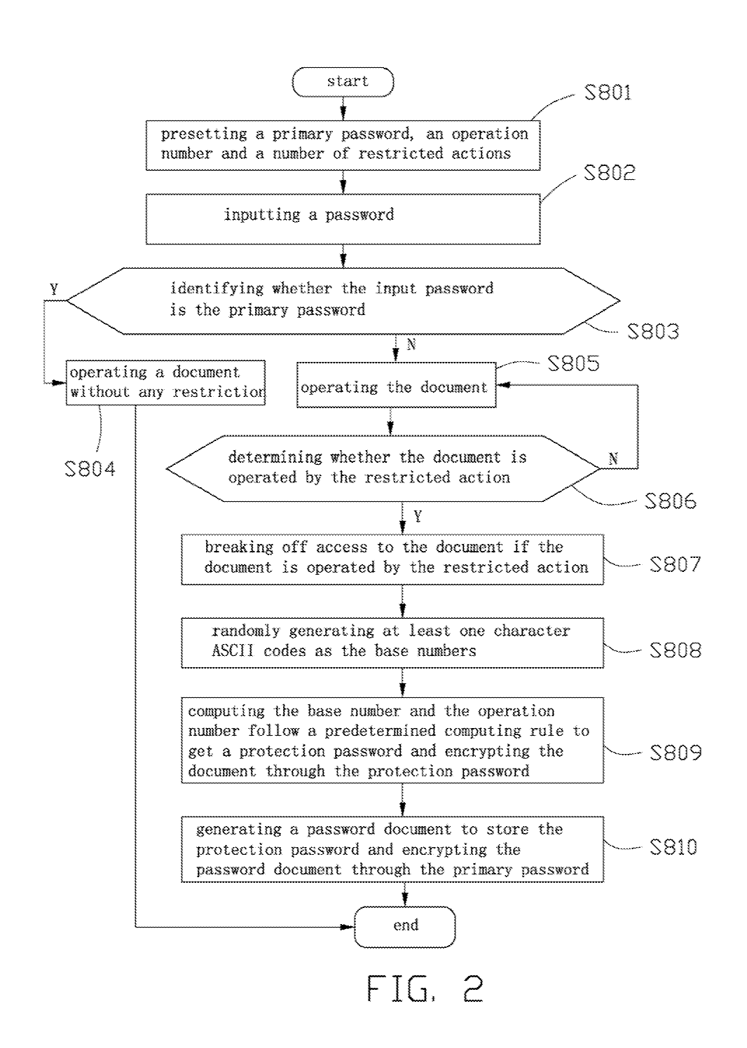

Also referring to FIG. 2, a document encrypting method for encrypting the document illegal operated, according to a first embodiment, includes step 801 to step 810 carried out by the document encrypting system 1.

Step 801: presetting a primary password, an operation number and a number of restricted actions.

Step 802: inputting a password.

Step 803: identifying whether the input password is the primary password.

Step 804: operating a document without any restriction if the input password is the primary password. As thus, the document can be operated without any restriction if it is operated by the author.

Step 805: operating the document.

Step 806: determining whether the document is operated by the restricted action and returning to step 805 if the document is not operated by the restricted action.

Step 807: breaking off access to the document if the document is operated by the restricted action.

Step 808: randomly generating at least one character ASCII codes as the base numbers.

Step 809: computing the base number and the operation number follow a predetermined computing rule to get a protection password and encrypting the document through the protection password.

Step 810: generating a password document to store the protection password and encrypting the password document through the primary password.

While various exemplary and preferred embodiments have been described, it is to be understood that the invention is not limited thereto. To the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A document encrypting system for encrypting a document, the system comprising:
a memory configured for storing the document;
an input device configured for performing an action on the document;
an operating processor configured for detecting the action performed on the document by the input device;
an encrypting processor configured for comparing the ongoing action with a plurality of predetermined restricted actions, generating a protection password if the document is operated by the restricted actions, and encrypting the document through the protection password; and
an input/output bus configured for interconnecting with the memory, the input device, the operating processor, and the encrypting processor.

2. The system as claimed in claim 1, wherein the input device can be a keyboard, a touch screen, or a mouse.

3. The system as claimed in claim 2, wherein the encrypting processor comprises:
a presetting unit configured for presetting a primary password, an operation number, and the restricted actions;
a buffering unit configured for buffering the primary password, the operation number, and the restricted actions;
a comparing unit configured for comparing the actions detected by the operating processor with the restricted actions and generating a warning instruction if the action performed on the document is the restricted actions;
an encrypting unit configured for terminating the ongoing restricted actions and breaking off access to the document upon receipt of the warning instruction and generating the protection password base on a plurality of base numbers and the operation number; and
a password unit configured for generating a password document to store the protection password and encrypting the password document by the primary password.

4. The system as claimed in claim 3, wherein the restricted actions can be a copy action, a cut action, a delete action, and a paste action.

5. The system as claimed in claim 3, wherein the encrypting unit randomly generates at least one character ASCII codes as the base numbers.

6. The system as claimed in claim 5, wherein the encrypting unit computes the base number and the operation number follow a predetermined computing rule to get the protection password.

7. The system as claimed in claim 6, wherein the computing rule is hexadecimal addition.

8. The system as claimed in claim 3, wherein the encrypting processor comprises a identifying unit configured for identifying if the document is operated by an author who creates the document via inputting the primary password, generating and transmitting a terminate instruction to the comparing unit if the input password is the primary password, the comparing unit terminates the comparison when it receives the terminate instruction.

9. A document encrypting method for encrypting a document, the method comprising:
presetting a primary password, an operation number, and a plurality of restricted actions;
operating the document;
determining whether the document is operated by the restricted actions;
breaking off access to the document if the document is operated by the restricted action;
randomly generating at least one character ASCII codes as a plurality of base numbers;
computing the base numbers and the operation number follow a predetermined computing rule to get a protection password and encrypting the document through the protection password; and
generating a password document to store the protection password and encrypting the password document through the primary password.

10. The method as claimed in claim 9, further comprising: returning to operate the document if the document is not operated by the restricted action.

11. The method as claimed in claim 9, further comprising: inputting a password, identifying whether the input password is the primary password and operating a document without any restriction if the input password is the primary password between presetting a primary password, an operation number and a number of restricted actions and determining whether the document is operated by the restricted action.
